(19) United States
(12) Patent Application Publication
(10) Pub. No.: US 2025/0316251 A1
(43) Pub. Date: Oct. 9, 2025

(54) METHOD AND SYSTEM FOR PROCESSING MUSIC AUDIO DATA BASED ON AN ENERGY VALUE AND A MUSICAL FEATURE

(71) Applicant: ALGORIDDIM GMBH, München (DE)

(72) Inventors: Federico TESSMANN, München (DE); Kariem MORSY, München (DE)

(73) Assignee: ALGORIDDIM GMBH, München (DE)

(21) Appl. No.: 18/864,413

(22) PCT Filed: May 9, 2022
(86) PCT No.: PCT/EP2022/062520

§ 371 Date: Nov. 8, 2024

(51) Int. Cl. G10H 1/00; G10H 1/053; G10H 1/46

(52) U.S. Cl. CPC G10H 1/0025; G10H 1/0091; G10H 1/053; G10H 1/46; G10H 2210/131; G10H 2220/201; G10H 2220/376

(57) ABSTRACT

The present invention relates to a method for processing music audio data including the steps of receiving an energy value related to a user or an object, providing input audio data representing a piece of music, obtaining output audio data based on the input audio data, playing audio data obtained from the output audio data, where obtaining the output audio data includes applying at least one audio effect, and where the audio effect is controlled based on the energy value.

The present invention relates to a method for processing music audio data comprising the steps of providing input audio data representing a piece of music, obtaining output audio data based on the input audio data, and playing audio data obtained from the output audio data. Furthermore, the invention relates to a system configured to carry out such a method.

Method and systems of the above-mentioned type are implemented by conventional digital music players, which allow a user to select a piece of music from among a plurality of different pieces of music and to play the selected piece of music, such as to listen thereto via speakers or headphones. Music players are in particular known as mobile devices, such as smartphones, which store a plurality of pieces of music on an internal storage or stream the music through the Internet by means of wireless communication means of the mobile device, such as a GSM unit or a Wi-Fi unit.

Some music players are known, which include sensors to detect a movement of a user, for example by means of an internal gyroscope, and which adapt the playback of the piece of music to a motion of the user. For example, some devices are configured to select, from a music library, a piece of music having a tempo (BPM value) that corresponds to a measured step frequency of the user, in order to support a user's workout. Other devices receive individual instrument tracks of a multi-track version of a piece of music and create a new composition of the piece of music depending on a detected motion of the user. There is still another approach of motion-based music playback, which changes a tempo of a piece of music during playback, such as to match the tempo of the music with the detected motion of the user.

The conventional approaches have been found unsatisfactory by users during practical use. First of all, motion based music players which use individual vocal or instrument tracks (stems) for composing music based on detected motion have a limited usability as it is difficult or usually impossible for most pieces of music to obtain the original source files for the individual tracks. Users want to play the actual pieces of music from regular single stereo files as they are widely available through download stores and streaming services. Furthermore, for other conventional music players, users have reported that the change in motion such as a change from normal walking towards running or towards standstill, is not adequately supported by a corresponding change of the music in the conventional systems. In addition, all conventional methods usually result in a disruptive change of the musical composition and in unexpected interruptions of the flow of the music or a break of tension. In particular, tempo changes or unexpected changes of the musical composition are considered disturbing in view of the expected continuity of the music.

It is therefore an object of the present invention to provide a method and a system for processing music audio data, which allow a more natural reaction of the music playback to a change in activity or energy of a user or an object, wherein unexpected interruption of the flow of music is avoided.

According to a first aspect of the present invention, this object is achieved by a method for processing music audio data comprising the steps of receiving an energy value related to a user or an object, providing input audio data representing a piece of music, obtaining output audio data based on the input audio data, and playing audio data obtained from the output audio data, wherein obtaining the output audio data includes applying at least one audio effect, and wherein the audio effect is controlled based on the energy value.

Therefore, according to an important feature of the first aspect of the invention, an audio effect is applied to the piece of music, which depends on the energy value, i.e. which is controlled based on the energy value. The inventors have found that audio effects are able to affect the perceived energy of the music or a perceived tension level inherent to the music without causing a disruptive change of the composition and without interrupting the flow of the music, e.g. by introducing interruptions of the musical meter of the output audio data. The perceived character of the music may therefore be matched to an energy value, in particular a change of the energy value of a user or an object, while an unexpected or disturbing interruption of the music is avoided.

In the context of the present disclosure, a piece of music is in particular an individual, entire title or a song (for example the song “Billie Jean” from Michael Jackson, playback duration 04:53), which are available through conventional music distribution platforms, such as Apple Music, Spotify, etc. One entire title or one entire song distributed by such platforms is referred to as one piece of music in the sense of the present disclosure.

Furthermore, within the present disclosure, an audio effect is defined as a change of an audio signal which typically modifies the shape of the waveform or a part of the waveform of the audio signal. In this respect, audio effects are distinguished from simple volume changes that just scale the amplitude of the waveform without modifying the shape of the waveform. Mere value scaling of the entire waveform or volume changes of the entire mixed input audio signal of the piece of music therefore do not qualify as audio effects in the sense of the present invention.

An audio effect according to the present invention may include an audio filter. In particular, audio filters may be defined as devices or processes that reduce, attenuate or remove components or features of an audio signal, i.e. perform complete or partial suppression of some aspect of the signal. For example, audio filters may remove some, but not all, frequencies or frequency bands from an audio signal. Therefore, audio filters are particularly suitable for changing music without altering its composition or basic character, because they operate on the original audio data by either taking away only some, but not all of the signal components of the audio signal, or copying or shifting audio signals, or overlaying different portions of the same original audio data.

An audio effect according to the present invention may comprise at least one of
an equalizer, in particular a parametric equalizer, for example with low, middle, high frequency bands, or with any other frequency bands,
a high-pass filter,
a low-pass filter,
a band-pass filter,
a band-reject or notch filter,
reverberation,
a delay or echo effect,
a repeat effect,
an echo out effect or a reverb out effect, which is an echo or reverberation effect combined with a decrease in volume over time, for example over several seconds, until reaching silence,
a finite impulse response filter (FIR filter), which is a filter whose impulse response or response to any finite length input is of finite duration, because it settles to zero in finite time,
an infinite impulse response filter (IIR filter), which continues to respond to an input infinitely or almost infinitely, usually decaying,
an audio echo filter, which is an FIR filter that repeats a sound after a given delay while attenuating the repetitions,
a pitch change effect, in particular a tempo-preserving pitch change effect which changes pitch (perceived tone pitch) while keeping constant the tempo and/or rhythm of the music,
a white noise effect, which adds a sequence or random signals to the audio signal, in particular a sequence of samples where each sample is chosen randomly and independently from a gaussian distribution,
a sine wave, triangle wave, sawtooth wave or square wave effect, which adds a synthetic waveform of predetermined frequency to the audio signal or modulates the audio data with such waveform,
a wave-shaping effect which applies a mathematical function to each sample of the audio signal, for example a polynomial, tanh or stepwise linear function, such as to create effects like overtones, distortion, etc.,
a comb filter, which adds together the original audio signal with a slightly delayed copy such as to cause certain frequencies that are multiples of the delay to be amplified, while ones that are right in between multiples will be exactly out of phase with one another and cancel out,
a flanger, which performs a frequency modulation that uses a delay effect introduced to the signal in a feedback loop,
a phaser, which uses frequency-modulated sound mixed back into the original sound or a sound obtained by phase-shifting of a part of the signal,
a resonator, which uses a comb filter with a very high feedback and tuning parameters of the comb filter to align the pitch of the lowest peak in the spectrum with a desired musical note, such as to create an effect which strongly amplifies only sounds that contain that musical note and attenuates anything else.
a spatial audio effect, which localizes or shifts audio tracks, preferably uses decomposed tracks to localize or shift certain timbres included in the piece of music, such as certain instruments, in multiple dimensions, in particular in three dimensional space.

Furthermore, an audio effect according to the present invention may comprise at least one of a chorus effect, a vibrato effect, a tremolo effect, a compressor effect, a limiter effect, a gate effect, a distortion effect, a saturation effect, an overdrive effect, a vocoder effect, a harmonizer effect, a pitch shifter, a bit crusher effect (an audio effect producing distortion by reducing the resolution or band width of the input audio data), a loop roll effect, a beat roll effect, a beat masher, a censor effect, a back spin effect, a scratch effect (local tempo change or local variation of dynamic sample rate conversion and/or forward and reverse playback, without change overall tempo or beat grid), and a brake/vinyl stop effect (without change overall tempo or beat grid).

Furthermore, an audio effect may be created by combining two or more of the audio effects mentioned above or by combining at least one of the audio effects mentioned above with other audio effects. Examples for such combined effects are Macro Riser Effects, Endless Smile Effects or Easy Washout Effects, which each include a mix of high-pass filters, delay filter, reverberation and white noise effects to the signal, which are preferably added individually and their parameters slowly increased over time (for example over the duration of some beats or bars of the musical meter of the piece of music)) to create an increase in perceived energy or tension of the music, wherein all parameters are controlled by controlling only one combined parameter, from which all the parameters of the contained effects are computed.

Controlling the audio effect in the sense of the present invention may in particular comprise at least one of selecting the audio effect from a plurality of (different) audio effects, starting or stopping application of the audio effect, setting or changing one or more effect parameters of the audio effect. Therefore, depending on the energy value, in particular a detected change of the energy value, a particular audio effect may be selected from a predefined list of audio effects. For example, if the method is carried out by a music playback system, the system may store a predefined list of audio effects as well as a set of predefined rules, by which predefined energy values or ranges of the energy value are associated to particular audio effects from the list of audio effects. Upon detection of a particular energy value, an associated audio effect may then be selected and applied to the audio data processed in the step of obtaining output audio data. In another embodiment, the method may include rules for starting or stopping application of an audio effect depending on a received energy value, or rules for setting or changing an effect parameter of an audio effect depending on the energy value.

In a preferred embodiment of the present invention, the audio effect is controlled while the audio data are played, wherein the musical meter is maintained, without interruption of the playback or without changing the tempo (BPM value) of the music. In other words, the audio effect may keep the musical meter and the tempo of the piece of music substantially constant. Therefore, the energy value may be received during playback and in particular a change of the energy value may be determined during playback, and then, while playback continues without interruption, i.e. without a pause or an interval of silence or any other break, in particular without a break in the flow of the music, a current energy value or change of the energy value is determined and the audio effect is controlled in real-time, such as to reflect the energy value or the change in energy value by a corresponding change of the perceived energy or tension of the music. Due to the nature of audio effects, the result of controlling the audio effect can readily be perceived by the user as a change in energy or tension or character of the piece of music, however, the flow of music determined by the continuing musical meter, is not altered. It should be noted that, in this disclosure, the term musical meter refers to the regularly recurring patterns and accents such as bars and beats within the piece of music, which are structured according to the time signature of the piece of music, for example as four-four times, three-four times etc. Metric onsets are not necessarily sounded, but are nevertheless implied by the performer (or performers) and expected by the listener. The timings of the actual onsets in the audio signal or the rhythmic accents of some instruments, for example, may deviate from the musical meter and may in particular be shifted by the audio effect for the duration of some beats, while the perceived musical meter is maintained.

According to a preferred embodiment of the invention, the method further comprises a step of analyzing audio data obtained from the input audio data, such as to retrieve at least one musical feature of the piece of music, wherein the audio effect is controlled based on the musical feature and the energy value. According to this embodiment, control of the audio effect does not only depend on the energy value of the user or the object, but also takes into account the musical content of the piece of music, either in a particular part of the piece of music or over the entire length of the piece of music. By knowing a musical feature of the piece of music, selecting, timing or adjusting the audio effect can be carried out in a much more sophisticated manner in order to achieve the desired acoustic result. For example, if a piece of music, at the current playback position during playback, has a frequency spectrum (musical feature) with only minor signal portions in the low frequency range (e.g. a part without bass), a selection of a high-pass filter or a low-pass filter as an audio effect may not be suitable, since a low-pass filter would basically result in silencing the entire music, and a high-pass filter would basically not affect the music at all. Therefore, based on such a detected musical feature at the current playback position, which refers to the frequency spectrum at the playback position or within a playback region around the playback position, the method may apply a predefined rule which avoids selection of a high-pass filter or a low-pass filter but instead uses a different audio effect, for example a reverberation effect from the list of available audio effects.

In general, the musical feature may be a feature of the entire piece of music, such as tempo (BPM value), musical key, a musical genre or the like. Musical features related to the entire piece of music may be obtained from metadata of the piece of music, which are for example included in the audio file and can be read out by the method. Alternatively, the actual signals represented by the audio data may be analyzed in order to derive therefrom the musical feature. However, in preferred embodiments of the invention, the musical feature is a feature of the piece of music at a current playback position or within a playback region, the playback region being a region along the time axis of the piece of music, which contains the current playback position and has a length shorter than the length of the piece of music. The musical information derivable from analyzing the piece of music at the current playback position or playback region is much more useful for the method for deciding how to control the audio effect in order to achieve a desired change of the perceived energy or tension of the music right at the current playback position. This is because energy or tension of the piece of music usually varies significantly during playback of the piece of music according to the artistic composition of the music. Such changes are reflected by changes in musical timbres, changes in rhythm, etc. In order to efficiently control the audio effect, it is therefore advantageous to analyze musical features at the current playback position or within the playback region. The playback region may for example be one or a few beats of the musical meter of the piece of music.

The musical feature may in particular relate to at least one of
a tempo of the piece of music,
a musical meter or a beat grid of the piece of music,
a timbre of the piece of music or included in the piece of music,
a frequency or frequency spectrum of an audio signal of the piece of music,
an amplitude of an audio signal of the piece of music,
an RMS value of an audio signal of the piece of music,
an amplitude onset of an audio signal of the piece of music.

The above-mentioned features have been found by the inventors to have a significant effect on the musical energy or the musical tension, in particular when retrieved at a current playback position or a current playback region, and they may therefore be determined alone or in any combination with one another in order to obtain a kind of musical snapshot of the piece of music at the current playback position, which may form a basis for the method to automatically decide how to control at least one audio effect in order to change musical energy or tension, such as to reflect a current energy value or change in energy value.

A musical feature may refer to one or more musical timbres included in the piece of music, in particular included in the audio signal at the current playback position. Different musical timbres included in a piece of music may originate from different sound sources, such as different musical instruments, different software instruments or samples, different voices etc. In particular, a certain timbre may refer to at least one of:
a recorded sound of a certain musical instrument (such as a bass, piano, drums (including classical drum set sounds, electronic drum set sounds, percussion sounds), guitar, flute, organ etc.) or any group of such instruments;
a synthesizer sound that has been synthesized by an analog or digital synthesizer, for example to resemble the sound of a certain musical instrument (such as a bass, piano, drums (including classical drum set sounds, electronic drum set sounds, percussion sounds), guitar, flute, organ etc.) or any group of such instruments;
a sound of a vocalist (such as a singing or rapping vocalist) or a group of vocalists.

A timbre may be formed by a combination of a plurality of different timbres mixed together.

Timbres relate to specific frequency components and distributions of frequency components within the spectrum of the audio data as well as temporal distributions of frequency components within the audio data, and they may be separated through an artificial intelligence system specifically trained with training data containing these timbres, as will be explained in more detail later.

In a preferred embodiment of the present invention, the method further includes a step of determining a change of the energy value while the audio data are played, and wherein at least a first effect is applied upon determination of a reduction of the energy value from a value above a predetermine first threshold value to a value below the first threshold value, wherein the first effect is preferably at least one audio effect selected from:
repeat effect,
looper effect,
echo effect,
echo out effect or a reverb out effect,
a low-pass filter,
a fade-out effect,
a pitch change effect which reduces the pitch.

The above effects have been found by the inventors to produce a calm-down effect of the energy or tension of the piece of music, and they are therefore regarded as suitable effects to support the impression of a user that a reduction of the energy value is appropriately reflected by a perceivable change of the music.

In a further preferred embodiment of the present invention, the method further includes a step of determining a change of the energy value while the audio data are played, and at least a second effect is applied upon determination of an increase of the energy value from a value below a predetermined second threshold value to a value above the second threshold value, wherein the second effect is preferably at least one audio effect selected from:
high pass filter effect
gate filter effect
white noise effect
macro riser effect
endless smile effect
easy washout effect
increasing pitch.

The above-mentioned effects have been found to produce an energizing or animating effect to the music, such as to increase energy or tension of the music during playback. These effects are therefore found to improve a user's impression that an increase of the energy value of the user or object is appropriately reflected by a perceivable change of the music.

The method of the present invention may further comprise a step of performing a temporal variation of at least one effect parameter of the audio effect during application of the audio effect. This provides more options to manipulate the music through the audio effect, for example by gradually increasing/decreasing the cut-off frequency (effect parameter) of a high-pass filter or a low-pass filter, or by gradually increasing/decreasing the pitch shift value (effect parameter) of a pitch shift effect, or by gradually reducing the delay time of an echo effect, or by gradually reducing the repeat length of a loop effect.

In another embodiment, the audio effect may be controlled based on a tempo of the piece of music and/or a musical meter of the piece of music, which may further contribute to the audio effect smoothly fitting in the flow of music, in particular into the musical meter of the piece of music. For example, a delay effect may be used with a delay time (effect parameter) synchronized with the tempo/BPM of the piece of music. Furthermore, obtaining the output audio data may include applying a periodic audio effect formed by periodically repeating the audio effect or formed by periodically changing an effect parameter of the audio effect, wherein a timing of the periodic audio effect is based on a tempo and/or a musical meter of the piece of music.

The tempo value and/or the musical meter as used in the embodiments described above for controlling the audio effect may be obtained from a music library or from metadata of the input audio data. However, in order to increase precision of the determined tempo and/or musical meter and to improve flexibility of the method when metadata or other information are not available, the method may further comprise a step of analyzing audio data obtained from the input audio data, such as to retrieve the tempo value and/or the musical meter as a musical feature of the piece of music.

According to a second aspect of the present invention, the above-mentioned object is achieved by a method for processing music audio data comprising the steps of receiving an energy value related to a user or an object, providing input audio data representing a piece of music containing a mixture of different musical timbres, decomposing the input audio data to obtain at least a first decomposed track which represent at least one, but not all, of the musical timbres, obtaining output audio data based at least on the first decomposed track and the energy value, playing audio data obtained from the output audio data.

According to the second aspect, at least one (first) decomposed track is used to produce the output audio data to be played. Since the decomposed track is obtained from the input audio data, i.e. includes one or more, but not all, of the timbres of the input audio data, the majority of the original basic character of the piece of music and the majority of the original composition may be preserved easily, while creating an audible change of the energy or tension of the music.

In the context of the present disclosure, input audio data preferably represent a piece of music obtained from mixing a plurality of source tracks, in particular during music production or during recording of a live musical performance of instrumentalists and/or vocalists. Thus, input audio data may usually originate from a previous mixing process that has been completed before the start of the processing of audio data according to the present invention. In particular, the mixed audio data may be included in audio files along with meta data, for example in audio files containing a piece of music that has been produced in a recording studio by mixing a plurality of source tracks of different timbres. For example, a first source track may be a vocal track (vocal timbre) obtained from recording a vocalist via a microphone, while a second source track may be an instrumental track (instrumental timbre) obtained from recording an instrumentalist via a microphone or via a direct line signal from the instrument or via MIDI through a virtual instrument. Usually, a plurality of such tracks are recorded at the same time or one after another. The plurality of source tracks are then transferred to a mixing station, wherein the source tracks are individually edited, various sound effects and individual volume levels are applied to the source tracks, all source tracks are mixed in parallel, and preferably one or more mastering effects are eventually applied to the sum of all tracks. At the end of the production process, the final audio mix, usually a stereo mix, is stored in a suitable recording medium, for example in an audio file on the hard drive of a computer. Such audio files preferably have a conventional compressed or uncompressed audio file format, such as MP3, WAV, AIFF or other, in order to be readable by standard playback devices, such as computers, tablets, smartphones or DJ devices. For processing according to the present invention, the input audio data may then be provided as audio files by reading the files from local storage means, receiving the audio files from a remote server, for example via streaming through the Internet, or in any other manner.

Input audio data according to the present invention usually represent stereophonic audio signals and are thus provided in the form of stereo audio files, although other types, such as mono audio files or multichannel audio files may be used as well.

Furthermore, in the context of the present disclosure, decomposing input audio data refers to separating or isolating specific timbres from other timbres on the sound domain, which in the original input audio data were mixed in parallel, i.e. overlapped on the time axis, such as to be played together within the same time interval. Likewise, it should be noted that recombining or mixing of audio data or tracks refers to overlapping in parallel, summing, downmixing or simultaneously playing/combining corresponding time intervals of the audio data or tracks, i.e. without shifting the audio data or tracks relative to one another with respect to the time axis. Decomposing is therefore to be distinguished from parsing or cutting an audio track on the time domain into separate, different intervals along the time axis.

Decomposing the input audio data may be carried out by an analysis of the frequency spectrum of the input audio data and identifying characteristic frequencies of certain musical instruments or vocals, for example based on a Fourier-transformation of audio data obtained from the input audio data. In a preferred embodiment of the present invention, the step of decomposing the input audio data involves processing of audio data obtained from the input audio data within an artificial intelligence system (AI system), preferably a trained neural network. In particular, an AI system may implement a convolutional neural network (CNN), which has been trained by a plurality of data sets for example including a vocal track, a harmonic/instrumental track and a mix of the vocal track and the harmonic/instrumental track. Examples for conventional AI systems capable of separating source tracks such as a singing voice track from a mixed audio signal include: WO 2021/175455 A1, WO 2021/175457 A1, Prétet, “Singing Voice Separation: A study on training data”, Acoustics, Speech and Signal Processing (ICASSP), 2019, pages 506-510; “spleeter”—an open-source tool provided by the music streaming company Deezer based on the teaching of Prétet above, “PhonicMind” (https://phonicmind.com)—a voice and source separator based on deep neural networks, “Open-Unmix”—a music source separator based on deep neural networks in the frequency domain, or “Demucs” by Facebook AI Research—a music source separator based on deep neural networks in the waveform domain. Some of these tools accept music files in standard formats (for example MP3, WAV, AIFF) and decompose the song to provide decomposed/separated tracks of the song, for example a vocal track, a bass track, a drums track, an accompaniment track or any mixture thereof.

A method according to the second aspect of the invention, including in particular all embodiments described hereinafter, may be combined with a method according to the first aspect of the present invention. In particular, at least one audio effect may be applied to any audio data processed in the method of the second aspect of the invention, in order to further affect the musical energy or tension of the piece of music depending on the energy value. Preferably, the audio effect may be applied to audio data obtained from the first decomposed track, which allows choosing and controlling suitable audio effects for particular timbres of the piece of music.

In a preferred embodiment of the invention of the second aspect, the method may further comprise a step of analyzing audio data obtained from the input audio data such as to retrieve at least one musical feature of the piece of music, wherein the output audio data are obtained based on the energy value and the musical feature, wherein the musical feature may be a general musical feature of the entire piece of music or, more preferably, a feature at a current playback position or within a current playback region. As described in more detail above with respect to the first aspect of the invention, determining a musical feature allows to more appropriately react to a change of the energy value, such as to effectively manipulate the musical energy or tension of the piece of music at the very point in time when a change of the energy value is determined.

The musical feature may in particular relate to a timbre of the piece of music at the current playback position or playback region, for example to existence or non-existence of a particular timbre, which may deliver valuable information for deciding how to obtain suitable output data including at least the first decomposed track. For example, if the musical feature indicates the presence of a vocal timbre at the current playback position, the method may decide to obtain output audio data from the decomposed vocal track only, such as to switch to an a cappella version of the piece of music, for example upon detection of a reduction of the energy value, whereas such a cappella version would be unreasonable in a case where the musical feature relating to the current vocal timbre at the playback position indicates that the piece of music does not contain any vocal component at that playback position.

Preferably, the first decomposed track or any other decomposed track mentioned in the present disclosure, may represent at least one timbre selected from
a vocal timbre,
an instrumental timbre, which may include a mixture of different timbres of different instruments,
a bass timbre,
a drums timbre,
a drum-and-bass timbre, which includes a sum of all drums and bass timbres of the piece of music,
a vocal complement timbre, which includes a sum of all timbres of the piece of music but vocal timbres,
a drums-bass complement timbre which includes a sum of all timbres of the piece of music but bass and drums timbres.

The above timbres were found to characterize music and in particular have significant influence on the energy or tension of a piece of music at a certain point in time. For example, the presence, loudness, rhythm or density of rhythm instruments such as bass or drums may alone or predominantly define an intensity or energy of the music. Adding, subtracting or modifying the gain or loudness of decomposed tracks including drums and/or bass timbres therefore usually have significant influence on the perceived energy of the music.

In a further preferred embodiment of the invention, the step of decomposing the input audio data comprises obtaining a set of different decomposed tracks representing different musical timbres of the piece of music, wherein the method further comprises recombining at least two of the decomposed tracks to obtain a recombined track, wherein a selection of decomposed tracks for recombination depends on the energy value and/or the musical feature, and wherein the output audio data are obtained from the recombined track. By recombining two or more different decomposed tracks, which all originate from the original input audio data, the output audio data may acoustically approximate the original piece of music to a desired level. Eventually, when the set of decomposed tracks is a complete set, such that a recombined track obtained from recombining all decomposed tracks of the complete set is audibly equal to the input audio data, the method is able to play a large number of different versions of the piece of music, including the original piece of music, depending on the selection of decomposed tracks for recombination. The method therefore provides a number of options to adapt the output audio data played and listened to by the user to the energy value or a change in energy value.

More preferably, the method further includes a step of determining a change of the energy value while the audio data are played, wherein the selection of the decomposed tracks for recombination is changed based on the change of the energy value and based on the musical feature while the audio data are played, without interruption of the playback. Since the decomposed tracks are all obtained from the same input audio data, i.e. the same piece of music and therefore share the same time axis as the original piece of music, switching between different decomposed tracks or different selections of decomposed tracks for recombination will result in smooth modifications of the energy or tension of the piece of music but not in an audibly unexpected break of the flow of the music or in an unnatural change of the basic musical composition.

In a further preferred embodiment of the present invention, when the energy value is within a predetermined range, the output audio data are obtained from a recombined track obtained from recombining all decomposed tracks or the output audio data are obtained directly from the input audio without using decomposed tracks, and, when the energy value is outside the predetermined range, the output audio data are obtained from only one of the decomposed tracks or from a recombined track obtained from recombining at least two, but not all, of the decomposed tracks, or from a recombined track obtained from recombining all of the decomposed tracks, wherein at least one of the decomposed tracks is muted or reduced in volume. Therefore, the method allows playback of the piece of music in a first mode in which the user listens to substantially the original version of the piece of music without recognizable modification, wherein a certain change of the energy value of the user or the object during playback of the music may cause switching to a second mode in which the playback of the piece of music is continued, wherein, however, in the second mode, one or more timbres that were included in the original piece of music, are attenuated or excised. As an example, a user may listen to the original piece of music in the first mode, whereas upon detection of a change of the energy value (for example drop of the energy value below a certain threshold) a decomposed drums track, which represents the drums timbre of the piece of music, is silenced or significantly attenuated, such that the user hears the piece of music smoothly continuing without drums.

In a further preferred embodiment of the present invention, the step of analyzing audio data obtained from the input audio data comprises decomposing the input audio data to obtain at least one (other) decomposed track which represent at least one, but not all, of the musical timbres of the piece of music, and analyzing audio data obtained from the decomposed track. Identifying a musical feature based on a decomposed track may achieve more precise results or would allow detection of musical features that would otherwise not easily or not precisely be derivable from the original (mixed) input audio data as such. It should be noted that the step of decomposing the input audio data to obtain the at least one other decomposed track for analyzing and retrieving the musical feature is preferably carried out in parallel or simultaneously to the above-mentioned step of decomposing the input audio data to obtain the first decomposed track. In particular, the method may decompose, for example in a first decomposition unit, the input audio data to obtain decomposed tracks for producing output audio data, and may, at the same time or simultaneously, decompose, for example in a second decomposition unit, the input audio data to obtain decomposed tracks for analyzing and retrieving the musical feature.

In a further preferred embodiment of the present invention, the step of obtaining output audio data further comprises generating audio data, preferably based on the musical feature, and mixing the generated audio data with audio data obtained from the input audio data. Generated audio data may in particular be obtained from a synthesizer generating synthetic sounds, or from digital audio data based on an algorithm, or from a sample player, which plays one or more sound samples at a specific point in time and/or at particular timings according to an algorithm. The algorithm may be controlled by a set of pitch and timing data, for example MIDI data.

When using generated audio data, the musical feature may relate to a tempo or a musical meter of the piece of music, and the generated audio data may include a periodic musical pattern, for example a drums pattern, generated such as to have a tempo or a musical meter synchronized to the tempo or musical meter retrieved from the piece of music. The generated audio data may therefore smoothly and naturally mix with the rest of the audio data of the piece of music.

In a further preferred embodiment of the present invention, the input audio data are first input audio data representing a first piece of music, wherein the method further comprises a step of providing second input audio data representing a second piece of music different from the first piece of music, and wherein the step of obtaining the output audio data comprises simultaneous processing of the first input audio data and the second input audio data. According to this embodiment, the musical impression of the piece of music may further be modified by using audio material from a second piece of music, for example by mixing to the first piece of music some elements, timbres or sequences from a second piece of music in order to adjust a perceived energy or tension of the first piece of music according to the energy value of the user or the object. Suitable measures for mixing together or otherwise processing audio material from two different songs as known as such to a person skilled in the art, in particular DJ features as known by DJs, may be used in embodiments of the present invention to enrich or otherwise modify the musical content of the first piece of music by using audio material of the second piece of music or vice versa. For example, depending on the energy value or change in energy in value, the method may automatically perform a crossfade between the first piece of music and the second piece of music, wherein known concepts such as beat matching and/or key matching between the first and second pieces of music may be applied to ensure a smooth transition between the two pieces of music. When playback of the first and/or the second piece of music is based on recombined tracks obtained from recombining decomposed tracks of the first and/or second piece of music, concepts of automated transitions as disclosed in US2021/0294567A1 may be implemented, for example.

In a preferred embodiment of a method according to the second aspect, which uses first and second input audio data, the step of obtaining the output audio data comprises replacing at least one of the decomposed tracks obtained from decomposing the first input audio data with an audio track obtained from the second input audio data, and recombining said audio track obtained from the second input audio data with at least one of the other decomposed tracks obtained from decomposing the first input audio data. Therefore, particular timbres of the first piece of music may be substituted by respective timbres of a second piece of music in order to change a perceived energy or tension of the first piece of music currently played. For example, a perceived energy of a piece of music may be enhanced by substituting the decomposed drums track of the first piece of music by a decomposed drums track of a second piece of music, which has a more intense or denser drums pattern or rhythm. Playback of the first piece of music will then continue, without interruption, but with more intense drums from a second piece of music.

According to a third aspect of the present invention, the above-identified object is achieved by a music playback system comprising an energy input device configured to receive an energy value related to a user or an object, an audio input device providing input audio data representing a piece of music, a music processing device configured to obtain output audio data based on the input audio data, and an audio output device configured to output music based on the output audio data, wherein the music processing device includes an audio effect unit for applying at least one audio effect to audio data obtained from the input audio data, and wherein the audio effect unit is adapted to be controlled by the energy value received through the energy input device. The music playback system is in particular adapted to apply and control an audio effect depending on an energy value related to a user or an object and will therefore achieve the same or corresponding effects as noted above for the first aspect of the present invention. In particular, the music playback system of the third embodiment of the present invention may be configured to carry out a method of the first embodiment of the present invention, in particular a method according to an embodiment described above.

In a preferred embodiment of the invention of the third aspect, the music processing device includes a music information retrieval unit, which is adapted to retrieve at least one musical feature of the piece of music, and wherein the audio effect unit is configured to control the audio effect based on information received from the music information retrieval unit. Therefore, the audio effect unit is preferably coupled to the music information retrieval unit, such as to exchange information regarding the at least one musical feature. It should be noted that the music information retrieval unit is operated simultaneously with operation of other parts of the music processing device and/or simultaneously with operation of the audio output device. In particular, the music information retrieval unit is preferably configured to analyze audio data obtained from the input audio data and retrieve at least one musical feature, wherein a processing speed of the analysis that is equal to or higher than the playback speed of the audio output device, such that not only the output audio data to be played at the current playback position are readily available but the at least one musical feature for the current playback position or playback region is available as well in order to allow instant control of the audio effect unit.

According to a fourth aspect of the present invention, the above object is achieved by a music playback system comprising an energy input device configured to receive an energy value related to a user or an object, an audio input device, providing input audio data representing a piece of music containing a mixture of different musical timbres, a decomposition unit for decomposing the input audio data to obtain at least a first decomposed track which represents at least one, but not all, of the musical timbres, and an audio output device configured to output music based on the first decomposed track and the energy value received through the energy input device. A music playback system according to the fourth aspect of the invention allows decomposing input audio data into at least one decomposed track and modifying the piece of music by using the at least one decomposed track. The system therefore is configured to achieve the same or corresponding advantages as described above with respect to the second aspect of the invention. Furthermore, the system of the fourth aspect of the invention may be configured to carry out a method of the first and/or the second aspect of the present invention and in particular the embodiments described above. Furthermore, the music playback system according to the fourth embodiment of the invention may comprise one or more features as described above with respect to the system of the third embodiment of the invention.

As an important feature of the music playback system of the fourth embodiment of the invention, the system includes a decomposition unit, which is configured to decompose the audio input data, such that the system is able to process mixed audio data, i.e. audio files readily available through music distribution services such as streaming platforms, for example Apple Music, Spotify, etc. It is therefore possible to modify a currently played piece of music by making louder or quieter, rearranging, or swapping the timbres included in the piece of music without requiring multi-track audio files to be provided, which are usually only available during production of music and are not easily available for most of the music. Preferably, a processing speed of the decomposition unit is higher as the playback speed allowing real-time decomposition of the input audio data and therefore real-time adaption of the music to changes of the energy value. More preferably, the decomposition unit contains an artificial intelligence unit, which includes a trained neural network. The artificial intelligence system may further be configured for a segment-wise decomposition of the input audio data, such that playback of output audio data can be started on the basis of a first segment of decomposed data, while a second, later segment of decomposed data is simultaneously being obtained by the decomposition unit. This allows in particular real-time decomposition and avoids any delays larger than about five seconds when starting the music or switching to another piece of music. Further details of a conventional example for implementing a decomposition unit, in particular for real-time decomposition based on neural networks, is disclosed in WO 2021/175455 A1 or WO 2021/175457 A1, the disclosure of which is included herein in its entirety.

In the music playback system of the fourth aspect of the invention, the music processing device may again include a music information retrieval unit adapted to retrieve at least one musical feature of the piece of music. The music information retrieval unit, although it should be connected to the audio input device to carry out an analysis of audio data obtained from the input audio data, is preferably a unit adapted to operate independently from and simultaneously with other parts of the music processing device and the audio output device. It may therefore use its own resources to allow analysis of the input audio data at the same time as the playback is in progress. In particular, the music information retrieval unit may comprise its own decomposition unit configured to decompose the input audio data to obtain at least a second decomposed track, which represents at least one, but not all, of the musical timbres of the piece of music, as well as an analyzing unit configured to analyze audio data obtained from the second decomposed track in order to retrieve the musical feature. In particular, the decomposition unit of the music information retrieval unit may include a separate artificial intelligence unit with a separate trained neural network, in addition to a possible artificial intelligence system of the decomposition unit generating the first decomposed track for the output audio data. In other words, the system may include a first decomposition unit for generating decomposed tracks for playback and a second decomposition unit for generating decomposed tracks for analyzing the piece of music and retrieving musical features.

According to a fifth aspect of the present invention, in order to solve the above object, there is provided a music playback system comprising a motion input device configured to receive a motion value related to a motion of the user or an object, an audio playback device configured to playback audio data representing a piece of music, wherein the audio playback device includes a playback control unit configured to control playback of the audio data based on the motion value received by the motion input device, wherein the playback control unit is configured to carry out at least one of the following control operations: stop playback of the audio data, if the motion value indicates that a motion of the user or the object has stopped, start playback of the audio data, if the motion value indicates that a motion of the user or the object has started, change to playback of audio data representing a different piece of music, if the motion value indicates that a motion of the user or the object has increased from a value below a predetermined threshold value to a value above the threshold value or has decreased from a value above a predetermined threshold value to a value below the threshold value, reverse playback direction, if the motion value indicates that a direction of the motion of the user or the object has changed. With a music playback system of the fifth aspect of the invention, it is possible to control playback of a piece of music based on motion of the user or an object, which ensures that motion of the user or the object is appropriately reflected by the music and playback can be controlled by the user intuitively without actually operating input means of the system, such as a touchscreen of a smartphone.

In all aspect of the present invention, in particular in aspects one to five and their embodiments described above, the energy value related to a user may be derived from any value of a property of the state of an individual that might be directly measured (for example a body temperature), or indirectly measured, (for example a pace (speed of moving forward or ahead) of a user). The energy value may be obtained from a combination of different measurements, for example by aggregating the pace with a heartbeat of the user.

If the energy value is determined based on a pace of the user, the energy value may for example be equal to the pace (p) of the user in meters per second multiplied by a heartbeat (h) of the user in beats per second, E=p*h. Different devices can be used to get the direct measurements, e.g. an Apple Watch can retrieve the pace as well as the heartbeat of the user. Furthermore, other ways may be used to measure the pace of a user such as combining the outputs of different sensors, for example a GPS sensor, an accelerometer, a gyroscope, a magnetometer, a combination of GPS and WiFi, a pedometer, etc. Each sensor may have different qualities and by combining them one can achieve better results. For example, GPS provides absolute position but with poor resolution and low update frequency. Accelerometers provide high frequency updates but only relative measurements. To compute an estimate of the pace the Kalman Filter could be used. It combines measurements of the sensors and a physical model to estimate the position of the user. With the estimated position one can then estimate the pace.

The energy value relating to a user or an object may refer to a motion of the user or the object. Receiving an energy value may therefore comprise detecting a motion of the user or the object. Accordingly, the energy input device of the music playback system may comprise a motion sensor adapted to detect a motion of the user or the object, such as an acceleration or a velocity or a periodic movement, etc. For example, the object may be a vehicle driven by the user or transporting the user as a passenger, or a workout device, wherein the motion sensor may detect a velocity of the vehicle or an acceleration of the workout device. The motion sensor may comprise an optical sensor, such as a camera, detecting motion by analysis of the pictures taken by the camera.

Alternatively, the motion sensor may be included in a smartphone or may be placed anywhere near the body of the user, such as in a piece of clothing or in an article of footwear, in order to detect a motion of the user. Other parameters may be detected alternatively or in addition to detecting motion, which may represent an energy value of the user, for example a step frequency detector. In a further embodiment, a vital parameter sensor may be used to detect at least one vital parameter of the user, for example a heart rate, breathing rate, blood pressure or similar parameters, and an energy value may then be obtained from such a parameter or from a combination of such parameters.

In a further embodiment, the energy value may be determined through a brain-computer interface (BCI) measuring the electrical activity of the brain of a user (e.g. through Electroencephalography (EEG)).

In a further embodiment, the energy value may be directly input by the user through an input device, such as a touchscreen, a mouse, a keyboard, or another control element, for example a slider, a swingable lever, a rotary knob, etc.

Examples for energy values may include:
an energy value obtained from a brain computer interface measuring brain activity, which may assume the values “Relaxed”, “Neutral”, “Concentrating”,
an energy value of an object obtained from measuring the speed of a car, which may assume the values “standing”, “driving slow”, “driving fast”;
an energy value of a user obtained from measuring pace of a runner, which may assume the values “standing”, “walking”, and “running”;
an energy value of a user obtained from measuring a heart rate during a workout of the user, which may assume the values “very slow”, “slow”, “normal”, “fast” and “very fast”;
an energy value of a user obtained from measuring movement of a dancer, which may assume the values “standing still”, “moving slow” and “moving fast”.

As an example for a continuous energy value range, an energy value may be provided which ranges from a minimum floating point value (e.g. 0.0%) to a maximum floating point value (e.g. 100.0%). As an example for a discrete energy value range, an energy value may be provided from a range which contains the discrete values 1, 2, 3, 4.

Furthermore, the aspects of the invention may be implemented by a mobile device or a wearable, preferably a smartphone or a smart watch, running a software application, wherein said mobile device or wearable may comprise user input means and audio output means for outputting audio signals to a user via headphones or speakers. In particular, the mobile device or wearable may form substantially all parts of the system, in particular including the energy input device or the motion input device, the audio input device, the music processing unit or the decomposition unit, as well as the audio output device.

The methods and systems of the present invention are in general suitable for supporting a user during running, workout, dancing, riding a bicycle, driving a car or another vehicle, or during any other activity.

The invention is now further explained based on preferred embodiments with reference to the drawings, in which

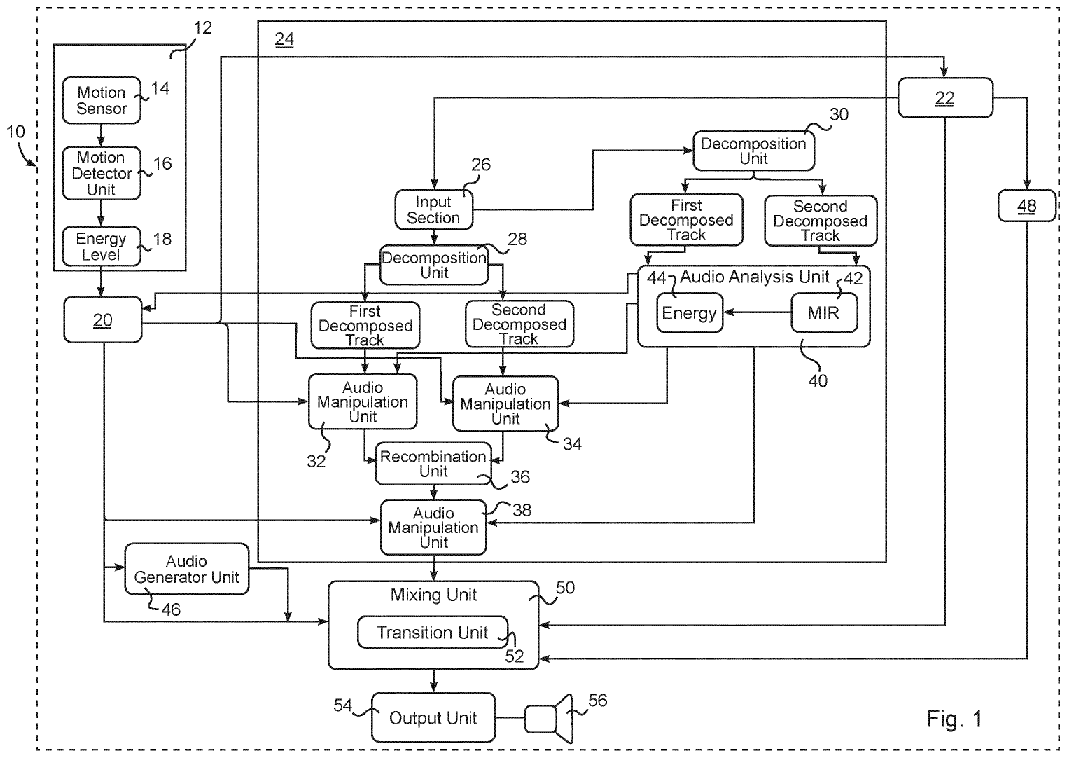

FIG. 1 shows an outline of a music playback device according to a first embodiment of the present invention,

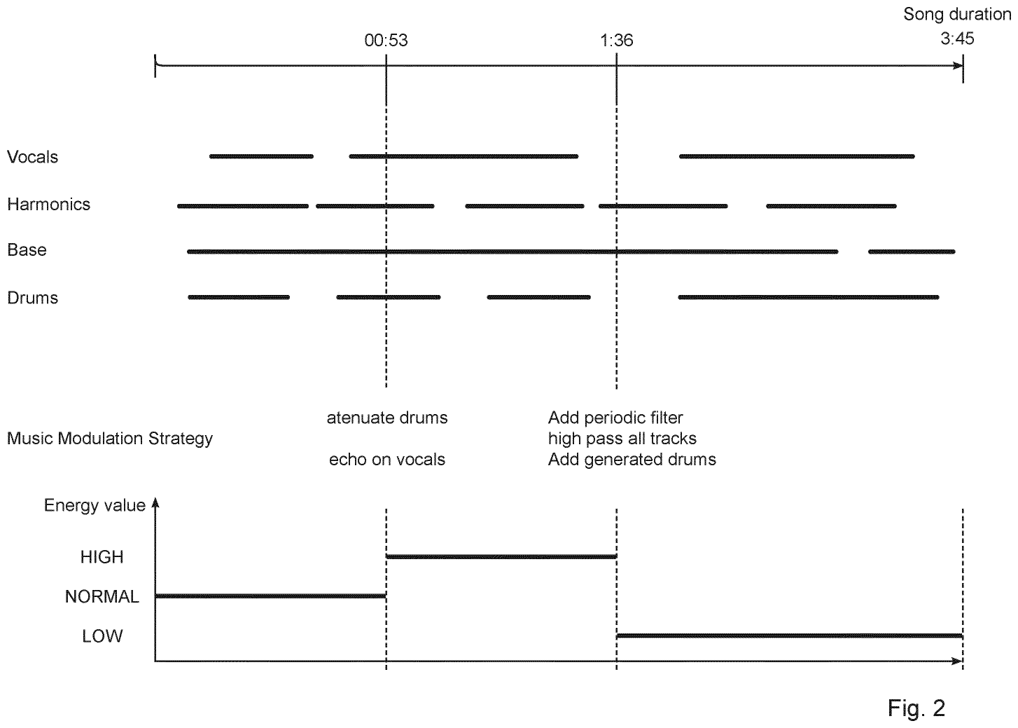

FIG. 2 shows a schematic diagram of a method according to a second embodiment of the present invention,

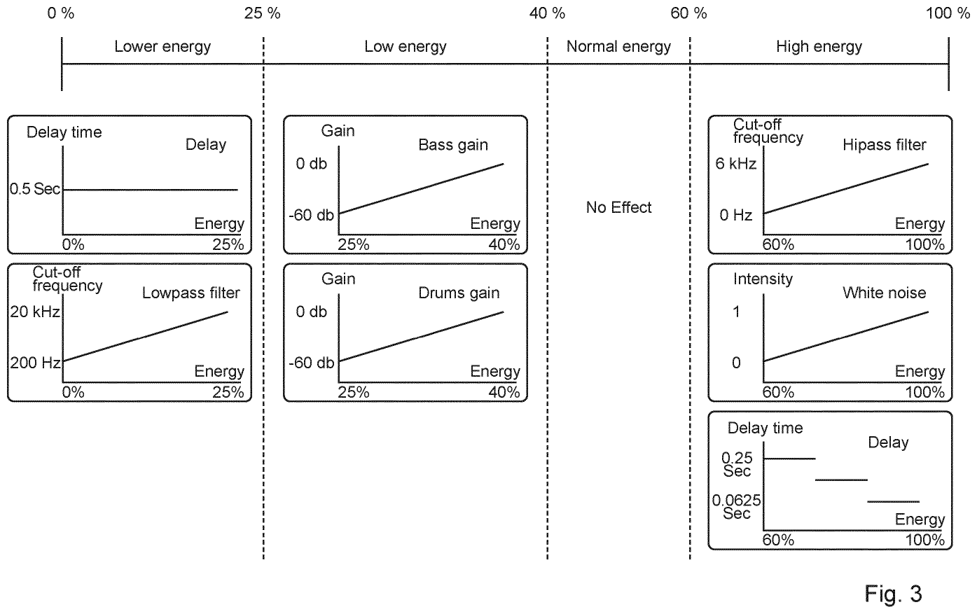

FIG. 3 shows a module control chart of a method and a system according to a third embodiment of the present invention, and

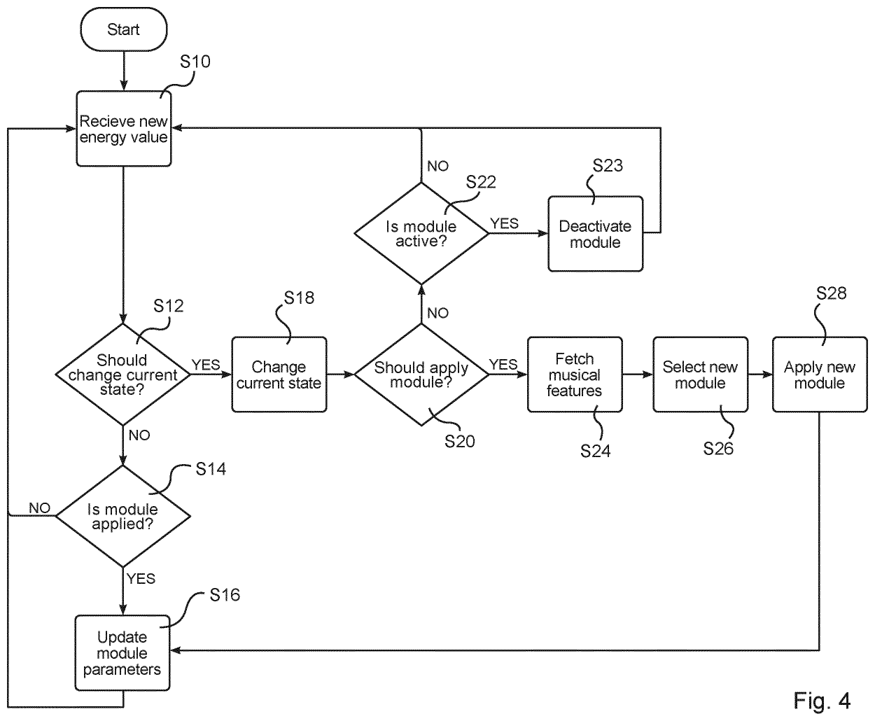

FIG. 4 shows a flow chart of a module control algorithm that may be implemented in a method and a system according to the present invention.

According to the first embodiment shown in FIG. 1, a music playback system is embodied as a mobile device 10, in particular a smartphone, which contains standard electronic components such as a processor, RAM, ROM, a local storage device, a display, user input means such as a touchscreen or a microphone or a motion sensor, audio output means such as internal speakers or a headphone port, wireless communication means such as a Wi-Fi circuit, a GSM circuit or a Bluetooth circuit, and power supply means such as a rechargeable internal battery. As known as such, mobile device 10 includes all its components within a housing, such that the mobile device can easily be carried along by a user.

Further components and units for implementing the present invention as will be described below may be implemented by a suitable software application running on the processor and the RAM of the mobile device 10.

It should be noted that, in FIG. 1, arrows with double lines represent audio data, while arrows with single lines represent control data.

The music playback system comprises an energy input device 12, which forms an energy input device and/or a motion input device according to the present invention and which includes, in the present embodiment, a motion sensor 14 such as an acceleration sensor or a gyroscope, configured to detect motion of the mobile device 10 and therefore a motion of a user carrying the mobile device 10. Motion sensor 14 may be connected to a motion detection unit 16, which reads the sensor output of the motion sensor 14 and derives therefrom a value indicating a type, intensity or other parameter of the detected motion. The result may be transferred to an energy value determination unit 18, which calculates an energy value based on the detected motion parameters. For example, energy value determination unit 18 may determine that the energy value is HIGH, when an acceleration or velocity detected by the motion detection unit 16 exceeds a certain predetermined threshold value, may determine that the energy value is LOW, if the acceleration or velocity detected by motion detection unit 16 is below a predetermined second threshold value, and may determine that the energy value is NORMAL when the acceleration or velocity detected by the motion detection unit 16 is between the first threshold value and the second threshold value. Alternatively, the energy value determination unit 18 may directly take an acceleration or velocity detected by motion detection unit 16, or an acceleration or velocity multiplied by a factor, as the energy value.

The energy value determined by energy input device 12 may be transferred and input into a music energy modulation unit 20 for modulating a piece of music as will be described in more detail later.

Mobile device 10 further includes an audio input device 22 adapted to provide digital audio input data representing a piece of music. Audio input device 22 may include a song selection unit allowing a user to select a desired piece of music from a library of pieces of music stored locally on the mobile device 10 or remotely on a music distribution platform. In a manner known as such, audio input device 22 may be configured to receive digital audio data from a remote server via streaming, for example from a platform such as Apple Music or Spotify. The input audio data may be received as digital audio files, in particular encrypted and/or compressed audio files, wherein each audio file contains one piece of music. Audio input device 22 may be configured to preprocess the received audio files, for example to decompress and/or decrypt the files as known as such for digital music players.

The input audio data provided by audio input device 22 are transferred to a first processing device 24 in which the piece of music is received at an input section 26. Input section 26 passes the input audio data to two decomposition units, a first decomposition unit 28 for generating decomposed tracks to be processed for outputting music, and a second decomposition unit 30 for producing decomposed tracks, which are analyzed to retrieve musical features, which are to be taken into account by music energy modulation unit 20 as will be described later.

The first decomposition unit 28 may comprise a trained neural network, which has been trained in advance by training data comprising at least a first source track referring to a first predetermined timbre of a piece of music, a second source track referring to a second predetermined timbre of the piece of music, and the final mixed version of the piece of music. After training, the decomposition unit 28 is ready to be used and is able to decompose a new piece of music, such as to derive therefrom a first decomposed track representative of a first musical timbre and a second decomposed track representing a second musical timbre. In the example of FIG. 1, the first decomposed track may be a decomposed vocal track, and the second decomposed track may be a decomposed drums track. However, other timbres may be used and more than two decomposed tracks may be produced by decomposition unit 24.

The first decomposed track may then be input into a first audio manipulation unit 32, which preferably includes at least one effect unit for applying at least one audio effect to the first decomposed track, and/or a volume setting unit for setting a volume level of the first decomposed track at a desired value. Likewise, the second decomposed track is input into a second audio manipulation unit 34, which may also include an effect unit and/or a volume setting unit. Audio data obtained from the first and second audio manipulation units 32, 34 are passed to a recombination unit 36, where they are recombined with one another, in particular mixed with one another, to obtain a recombined track. The recombined track is then preferably passed through another, third audio manipulation unit 38, which may include another audio effect unit, which allows application of another audio effect to the recombined track. The output of the recombination unit 36 or the third audio manipulation unit 38 then forms a first output track containing a processed version of the piece of music, which may be audibly equal to the original piece of music or a modified version of the piece of music.

The first processing device 24 preferably further includes the second decomposition unit 30, which receives the input audio data from the input section 26 for processing along a second signal path parallel to the first signal path running through the first decomposition unit 28 to the recombination unit 36. Again, second decomposition unit 30 may contain an artificial intelligence system including a trained neural network as described for the first decomposition unit 26. First and second decomposed tracks are obtained from the second decomposition unit 30, which may represent the same or other musical timbres contained in the piece of music.

First and second decomposed tracks of the second decomposition unit 30 are then passed to an audio analysis unit 40, in which the decomposed tracks are analyzed with regard to their audio content. In addition or alternatively, the audio analysis unit 40 may receive the (original) input audio data, for example directly from input section 26 or from audio input device 22, to allow analysis of the input audio data with regard to their audio content.

In particular, audio analysis unit 40 may include a music information retrieval unit (MIR unit) 42, which is configured to retrieve at least one musical feature from the decomposed tracks. For example, MIR unit 42 may determine whether or not the first decomposed track (or the second decomposed track) is substantially silent, such as to determine whether or not the piece of music contains a particular timbre at a specific playback position or playback region. As another example, the MIR unit 42 may determine a frequency spectrum of the audio signal at a specific playback position or an RMS (Root Mean Square) value of a number of amplitude signals of subsequent samples of the audio signal around the specific playback position. Based on one or more musical features retrieved by the MIR unit 42, a musical energy determination unit 44 may further determine a music intensity value representing a musical energy or tension of the piece of music at a specific playback position.

Audio analysis unit 40 may be connected to the music energy modulation unit 20 to deliver information and analysis results for the piece of music, such as one or more musical features or the music intensity value, to music energy modulation unit 20. Optionally, the data from audio analysis unit 40 may also be transferred to at least one of the first to third audio manipulation units 32, 34 and 38.

Music energy modulation unit 20 may further be configured to control at least one, preferably all, of first to third audio manipulation units 32, 34, 38 such as to control application of audio effects, control volume or otherwise manipulate one or more of the individual decomposed tracks and/or the recombined track.

Furthermore, music energy modulation unit 20 may control an audio generator unit 46, which may include a drums machine, a synthesizer, a sample player or any other means for generating audio data.

Mobile device 10 may further include a second processing device 48, which may be configured in the same or corresponding way as the first processing device 24, in particular with additional decomposition units, an additional audio analysis unit, an additional recombination unit and additional audio manipulation units as described above for the first processing device 24. Audio input device 22 may then be configured to allow selection of not only a first piece of music passed to the first processing device 24, but also a second piece of music different from the first piece of music, which is passed to the second processing device 48 for independent and parallel processing, such as to obtain a second output track, which may be a modified or unmodified version of the second piece of music.

Mobile device 10 further includes a mixing unit 50 adapted to mix together a plurality of audio tracks, in particular by summing the amplitudes of the audio signals of all audio tracks for each point in time along the playback axis, in order to obtain a playback track. Furthermore, mixing unit 50 may include an audio limiter, normalizer or compressor to control the output level.

In the first embodiment shown in FIG. 1, mixing unit 50 receives the first output track from the first processing device 24, the second output track from the second processing device 48, the generated audio track from audio generator unit 46 and a further audio track directly from audio input device 22. The latter audio track may in particular be the original version of the first piece of music and/or the original version of the second piece of music.

Mixing unit 50 may include a transition unit 52, which may control audio data associated to the first piece of music and audio data associated to the second piece of music in such a manner as to create a transition from the first piece of music to the second piece of music or vice versa, for example by carrying out a crossfade between the two pieces of music as known as such for DJ devices, for example.

The playback track which is output by mixing unit 50 is passed to an output unit 54 to prepare it for playback. Output unit 54 may in particular include a digital-to-analog converter to convert the digital audio data of the playback track into an analog audio signal, which may then be output by speakers or connected headphones 56. Alternatively, output unit 54 may comprise wireless communication means for sending audio data or audio signals obtained from the playback track to speakers or headphones 56 in a wireless manner, for example via Bluetooth.

A method according to a second embodiment of the present invention is now described with respect to FIG. 2. The method may be carried out by using a mobile device 10 as described above with respect to FIG. 1, wherein mobile device 10 may then be modified in such a manner that the first decomposition unit 28 and the second decomposition unit 30 of the first processing device 24, and preferably also the decomposition units of the second processing device 48, are configured to decompose the audio data into at least four different decomposed tracks representing four different timbres, in particular a vocal timbre, a bass timbre, a drums timbre and a harmonic timbre. The harmonic timbre may be defined as the sum of all timbres of the piece of music minus the vocal timbre, the bass timbre and the drums timbre. In addition, two additional audio manipulation units may then be provided to manipulate the two additional decomposed tracks before entering the recombination unit 36, i.e. two additional audio manipulation units corresponding to audio manipulation units 32 and 34.

In the example shown in FIG. 2, the piece of music is a song having a playback length of 3:45 (three minutes and 45 seconds). Furthermore, energy input device 12 is configured to output a user energy value in three levels, LOW, NORMAL and HIGH.

It is assumed that playback is started at the beginning of the song (at 00:00) and the user energy value is NORMAL during the beginning of the song, for example because the user is walking at a constant pace. Music energy modulation unit 20 is then configured to play an original, unmodified version of the song. More specifically, audio input device 22 delivers audio data of the song to input section 26, which passes the audio data simultaneously to first decomposition unit 28 and second decomposition unit 30. First decomposition unit 28 decomposes the audio data into decomposed vocal, harmonics, bass and drums tracks, which are again recombined with one another within recombination unit 36 and then passed further to mixing unit 50 as a first output track. Since the user energy value is NORMAL, music energy modulation unit 20 controls the first to third audio manipulation units 32, 34 and 38 in such a manner as to not apply an audio effect or anyhow modify the decomposed tracks or the recombined track, such that the first output track received by mixing unit 50 is acoustically identical with the original song delivered by audio input device 22. As an alternative, music energy modulation unit 20 may control audio input device 22 and mixing unit 50 in such a manner that, when the user energy value is NORMAL, the first output track is muted and the original audio data of the song are delivered directly from the audio input device 22 to the mixing unit 50.

At the same time, audio data of the song are decomposed by the second decomposition unit 30 in order to obtain decomposed vocal, harmonics, bass and drums tracks for analysis in audio analysis unit 40, i.e. determination of a musical feature and music energy, wherein the analysis results are transferred to the music energy modulation unit 20 as input values.

At a time 00:53, the activity of the user lowers, for example because the user stops walking. The energy input device 12 therefore changes its output of the user energy value from NORMAL to LOW, which is immediately recognized by music energy modulation unit 20. Music energy modulation unit 20 stores a number of rules how to control the first processing device 24, the second processing device 48, the audio generator 46 and/or the mixing unit 50 such as to reflect the change in user energy value by a respective change of the perceived energy or tension of the music, wherein information from the audio analysis unit 40 about current musical features or a current musical energy value of the song at the current playback position are taken into account.

In the present example, music energy modulation unit 20 recognizes through information from audio analysis unit 40 that the song at the current playback position 00:53 contains drums timbres. More particularly, as seen in FIG. 2, the drums timbre does not continue throughout the song; however, at 00:53, drums timbres are present in the song. Music energy modulation unit 20 stores a number of rules how to reduce the perceived energy of the music in response to a reduction of the user energy value. One of the rules is to attenuate drums in the song, which of course is only effective if the song in fact contains drums at the current playback position. In the present case, because drums are present at 00:53, music energy modulation unit 20 controls the audio manipulation unit 34 of the decomposed drums track such as to decrease the volume of the decomposed drums track. On the other hand, in a case that the audio analysis unit 40 determined that the song does not contain drums and the user energy value is set to LOW, music energy modulation unit 20 would apply a different rule for reducing the perceived energy of the music.

As another rule, music energy modulation unit 20 considers applying reverberation to the decomposed vocal track as a reaction to the reduction of the user energy value at 00:53. Since audio analysis unit 40 determines that the song contains a vocal timbre at 00:53, music energy modulation unit 20 decides that the rule of applying reverberation on the decomposed vocal track is reasonable and therefore controls the first audio manipulation unit 32 receiving the decomposed vocal track, such as to apply reverberation or an echo-out effect to the vocals (only).

Playback continues while the user energy value is LOW until a playback position 1:36, at which the energy input device 12 determines a change of the user's activity, for example from walking to sprinting, and switches its output to a HIGH user energy value. Music energy modulation unit 20 recognizes the change in user energy value and considers application of a set of rules predefined in order to control the mobile device 10 such as to reflect the increase of the user energy value by an increase of the perceived musical energy.

In the present example, audio analysis unit 40 determines that, at playback position 1:36, the frequency spectrum contains a significant amount of low-frequency portions. In addition or alternatively, audio analysis unit 40 determines that a decomposed bass track is not silent. Therefore, the music energy modulation unit 20 decides that application of a high-pass filter, which belongs to a set of predefined measures for increasing the perceived musical energy of a song, is a suitable measure in the present situation, and therefore controls the third audio manipulation unit 38 and/or another effect unit (not illustrated) included in the mixing unit 50 such as to apply a high-pass filter. More preferably, music energy modulation unit 20 may control the effect such that a cutoff frequency of the high-pass filter increases with time during playback, for example during a time period of ten seconds.

Furthermore, audio analysis unit 40 may determine a current tempo (BPM value) of the song at 1:36 and music energy modulation unit 20 may apply a periodic filter with a periodicity according to the tempo to one of the decomposed tracks or to the recombined tracks, in particular a delay filter with a delay time synchronized with the tempo.

Furthermore, audio analysis unit 40 determines that the song does not contain a drums timbre at 1:36, although drums would be an important contribution to the perceived energy. In order to nevertheless increase the perceived energy such as to reflect the increase in user energy value towards HIGH, music energy modulation unit 20 may decide to control audio generator unit 46 based on a tempo or beat grid or musical meter obtained from audio analysis unit 40 such as to generate a drums track having such tempo or beat grid, which is mixed with the song by mixing unit 50.

Closer to the end of the song near 3:45, or at a user's command to change to the next song, music energy modulation unit 20 and/or audio input device 22 may be controlled to select a second song. Selection of the second song may be performed automatically and may be based on the tempo of the first song as detected by audio analysis unit 40 and/or based on the current user energy value. Audio data of the second song are passed to the second processing device 48, which may be controlled by a second energy modulation unit (not illustrated) or by the music energy modulation unit 20 shown in FIG. 1, for modulating the perceived energy of the second song depending on the user energy value as described above for the first song. In the present case shown in FIG. 2, the second song may be started in a modified version according to the HIGH user energy value and an automatic transition may be carried out from the first song to the second song by transition unit 52.

After transition, playback of the second song is then controlled by the second processing device 48 and music energy modulation unit in accordance with the user energy value as described for the first song. Near the end of the second song, or at a user's command to change to the next song, a third song may be selected by audio input device 22 and input to the first processing device 24, and a transition may be carried out by transition unit 52 from the second song to the third song. Playback of the third song according to the user energy value will then be controlled again by the first processing device 24 and the music energy modulation unit 20 in the same manner as described above for the first song.

A third embodiment of the present invention will now be explained with reference to FIG. 3. The third embodiment is a modification of the first and the second embodiments, which means that only differences with respect to the first and second embodiments will be explained, while the remaining features and functions will not be described again and instead reference is made to the description of the first and the second embodiment above.

In a third embodiment, the energy value as determined by the energy input device, for example energy input device 12, ranges from 0% to 100%, wherein 0% relates to a minimum energy value or activity of a user or an object, for example representing standstill, whereas 100% relates to a maximum energy value or activity of the user or object, for example maximum activity, maximum acceleration or maximum speed. In the third embodiment, the total range of energy values from 0% to 100% is partitioned into four ranges, a first range from 0% to 25% (lower energy), a second range from 25% to 40% (low energy), a third range from 40% to 60% (normal energy) and a fourth range from 60% to 100% (high energy).

When an energy value is provided by an energy input device, for example energy input device 12, the system first determines in which of the above four ranges the energy value falls. Depending on the range associated with the energy value, the music energy modulation unit 20 selects a certain type of music energy modulation module to be applied to modify the piece of music. For example, if the energy value is between 0% and 25%, application of a delay effect and application of a low-pass filter are selected as suitable music energy modulation modules. As another example, if the energy value is between 25% and 40%, a reduction of the volume of the bass timbre (decomposed bass track) and/or a reduction of the volume of the drums timbres (decomposed drums track) are considered as suitable music energy modulation modules. As a further example, if the energy value is between 40% and 60%, no modulation of the music energy is considered and the piece of music is played in its original version. Furthermore, as another example, if the energy value is between 60% and 100%, application of a high-pass filter, white noise and/or a delay effect are considered suitable music energy modulation modules to increase the music energy.

As can further be seen in FIG. 3, depending on the specific energy value within a certain range, parameters of the respective music energy modulation modules may be set by the algorithm executed by the system. For example, a cut-off frequency as a parameter of the low-pass filter may be linearly increased, for example from 200 Hz to 20 kHz, when the energy value increases from 0% to 25%, while the delay time of the delay effect may remain constant at 0.5 seconds for all energy values within the first range. Furthermore, the volumes or gains of the bass and/or drums timbres, i.e. the volumes or gains of the decomposed bass track and/or the decomposed drums track, may be set according to the diagrams shown in FIG. 3, such as to increase linearly, for example from −60 dB to 0 dB when the energy value increases from 25% to 40%. Furthermore, a linear increase of the cut-off frequency of the high-pass filter and/or a linear increase of the intensity of the white noise effect may be applied when the energy value increases in the high-energy range. As a further example, a delay time of a delay effect applied in the high-energy range may be reduced when the energy value increases, wherein in FIG. 3 a stepwise reduction of the delay time in three steps is implemented according to different fractions (e.g. ½, ¼, ⅛) of the duration of the beat according to the BPM value, when the energy value increases from 60% to 100%.

FIG. 4 show a flowchart of a music energy modulation algorithm that may be executed by the system, preferably the music energy modulation unit 20, in accordance with an embodiment of the present invention, preferably in accordance with one of the first to third embodiments described above. After starting the algorithm, an energy value is received from energy input device 12 in step S10, and it is determined in step S12 whether the energy value indicates a change in the current state of the user or object, for example a change between different ranges of the energy value (for example between the ranges LOW, NORMAL, HIGH as in the second embodiment or ranges one to four in the third embodiment). If no change of the state is detected, it is decided in step S14 whether or not any music energy modulation module is currently applied. If a module is not applied, such as for example when the energy value is in a normal range, the algorithm returns to step S10. If a module is applied, any parameters of the module, for example effect parameters or volume/selection of decomposed tracks, are updated based on the energy value in step S16 and the algorithm returns to step S10.

If it is determined in step S12 that the current state has changed, in particular that the range of the energy value has changed, the change of the state is registered in step S18 and a decision is made in step S20 as to whether or not a music energy modulation module should be applied. This decision may for example be made based on the module control chart shown in FIG. 2 or based on the module control algorithm shown in FIG. 3. If it is decided that no module is to be applied, for example if the energy value is in a normal range, it is determined in step S22 whether or not a module is currently active. If no module is active, the algorithm returns to step S10, whereas if a module is active, the module is deactivated in step S23 to return to playback of the original piece of music, and the algorithm returns to step S10.

Instead, if it is decided in step S20 that a module is to be applied, information is retrieved from the piece of music in step S24, for example through audio analysis unit 40, to retrieve musical features from the piece of music. Based on the musical features and on the energy value, for example taking into account the rules shown in FIGS. 2 and 3, a new music energy modulation module is selected in step S26 and applied in step S28. The algorithm then proceeds to step S16, in which the parameter or parameters of the module are updated according to the energy value, for example, by controlling effect parameters or decomposed tracks as noted in FIG. 3. Afterwards, the algorithm returns to step S10.

In this manner, the energy value is continuously determined in step S10 and the music energy modulation modules are continuously controlled based on the energy value and the musical features such as to modulate the music of the piece of music and adapt a perceived energy of the music to reflect the energy value of the user or the object.

1. Method for processing music audio data comprising the steps of
receiving an energy value related to a user or an object,
providing input audio data representing a piece of music,
obtaining output audio data based on the input audio data,
playing audio data obtained from the output audio data,
wherein obtaining the output audio data includes applying at least one audio effect, and wherein the audio effect is controlled based on the energy value.

2. Method of claim 1, wherein controlling the audio effect comprises at least one of
selecting the audio effect from a plurality of audio effects,
starting or stopping application of the audio effect,
setting or changing an effect parameter of the audio effect.

3. Method of claim 1 or claim 2, wherein the audio effect is controlled while the audio data are played, without interruption of the playback.

4. Method of at least one of claims 1 to 3, further comprising a step of analyzing audio data obtained from the input audio data such as to retrieve at least one musical feature of the piece of music, wherein the audio effect is controlled based on the musical feature and the energy value.

5. Method of claim 3 and claim 4, wherein the musical feature is a feature of the piece of music at a current playback position or within a playback region, the playback region being a region along the time axis of the piece of music, which contains the current playback position and has a length shorter than the length of the piece of music.

6. Method of claim 5, wherein the musical feature relates to at least one of
a tempo of the piece of music,
a musical meter or a beat grid of the piece of music,
a timbre of the piece of music or included in the piece of music,
a frequency or frequency spectrum of an audio signal of the piece of music,
an amplitude of an audio signal of the piece of music,
an RMS value of an audio signal of the piece of music,
an amplitude onset of an audio signal of the piece of music.

7. Method of at least one of claims 1 to 6, wherein the audio effect includes at least one audio filter, preferably at least one audio filter selected from:
equalizer filter,
high pass filter,
low pass filter,
reverberation,
delay filter,
finite impulse response filter (FIR filter),
infinite impulse response filter (IIR filter),
audio echo filter.

8. Method of at least one of claims 1 to 7, further including a step of determining a change of the energy value while the audio data are played, and wherein at least a first effect is applied upon determination of a reduction of the energy value from a value above a predetermine first threshold value to a value below the first threshold value, wherein the first effect is preferably at least one audio effect selected from:
repeat effect,
echo effect,
echo out effect,
low pass filter effect,
fade-out effect,
reducing playback speed,
reducing pitch.

9. Method of at least one of claims 1 to 8, further including a step of determining a change of the energy value while the audio data are played, and wherein at least a second effect is applied upon determination of an increase of the energy value from a value below a predetermined second threshold value to a value above the second threshold value, wherein the second effect is preferably at least one audio effect selected from:
high pass filter effect
gate filter effect
white noise effect
increasing playback speed,
increasing pitch.

10. Method of at least one of claims 1 to 9, further including the steps of determining a change of the energy value while the audio data are played at a time when an audio effect is currently applied, and changing the effect parameter of the audio effect in response to determination of the change of the energy value.

11. Method of at least one of claims 1 to 10, further comprising a step of performing a temporal variation of at least one effect parameter of the audio effect during application of the audio effect.

12. Method of at least one of claims 1 to 11, wherein the audio effect is controlled based on a tempo of the piece of music and/or a musical meter of the piece of music.

13. Method of at least one of claims 1 to 12, wherein obtaining the output audio data includes applying a periodic audio effect formed by periodically repeating the audio effect or periodically changing an effect parameter of the audio effect, wherein a timing of the periodic audio effect is based on a tempo and/or a musical meter of the piece of music.

14. Method of claim 12 or claim 13, further comprising a step of analyzing audio data obtained from the input audio data such as to retrieve the tempo value and/or the musical meter as a musical feature of the piece of music.

15. Method for processing music audio data comprising the steps of
receiving an energy value related to a user or an object,
providing input audio data representing a piece of music containing a mixture of different musical timbres,
decomposing the input audio data to obtain at least a first decomposed track which represent at least one, but not all, of the musical timbres, and
obtaining output audio data based at least on the first decomposed track and the energy value,
playing audio data obtained from the output audio data.

16. Method of claim 15 and at least one of claims 1 to 14, wherein the audio effect is preferably applied to audio data obtained from the first decomposed track.

17. Method of claim 15 or claim 16, further comprising a step of analyzing audio data obtained from the input audio data such as to retrieve at least one musical feature of the piece of music, wherein the output audio data are obtained based on the energy value and the musical feature.

18. Method of claim 17, wherein the musical feature is a feature of the piece of music at a current playback position or within a playback region, the playback region being a region along the time axis of the piece of music, which contains the current playback position and has a length shorter than the length of the piece of music.

19. Method of claim 18, wherein the musical feature relates to at least one of
a tempo of the piece of music,
a musical meter or a beat grid of the piece of music,
a timbre of the piece of music or included in the piece of music,
a frequency or frequency spectrum of an audio signal of the piece of music,
an amplitude of an audio signal of the piece of music,
an RMS value of an audio signal of the piece of music,
an amplitude onset of an audio signal of the piece of music.

20. Method of at least one of claims 15 to 19, wherein the first decomposed track represents at least one timbre selected from
a vocal timbre,
an instrumental timbre,
a bass timbre,
a drums timbre,
a bass-and-drums timbre, which includes a sum of all bass and drums timbres of the piece of music,
a vocal complement timbre, which includes a sum of all timbres of the piece of music but vocal timbres,
a bass-drums complement timbre which includes a sum of all timbres of the piece of music but bass and drums timbres.

21. Method of at least one of claims 15 to 20, wherein the step of decomposing the input audio data comprises obtaining a set of different decomposed tracks representing different musical timbres of the piece of music,
wherein the method further comprises recombining at least two of the decomposed tracks to obtain a recombined track,
wherein a selection of decomposed tracks for recombination depends on the energy value and/or the musical feature, and
wherein the output audio data are obtained from the recombined track.

22. Method of claim 17 and claim 21, further including a step of determining a change of the energy value while the audio data are played, wherein the selection of the decomposed tracks for recombination is changed based on the change of the energy value and based on the musical feature while the audio data are played, without interruption of the playback.

23. Method of claim 21 or claim 22, wherein the set of decomposed tracks is a complete set, wherein a recombined track obtained from recombining all decomposed tracks of the complete set is audibly equal to the input audio data.

24. Method of at least one of claims 21 to 23, wherein,
when the energy value is within a predetermined range, the output audio data are obtained from a recombined track obtained from recombining all decomposed tracks or the output audio data are obtained directly from the input audio without using decomposed tracks, and,
when the energy value is outside the predetermined range, the output audio data are obtained
from only one of the decomposed tracks or
from a recombined track obtained from recombining at least two, but not all, of the decomposed tracks, or
from a recombined track obtained from recombining all of the decomposed tracks, wherein at least one of the decomposed tracks is muted or reduced in volume.

25. Method of claim 4 or claim 17, and optionally at least one other claim of claims 1 to 24, wherein the step of analyzing audio data obtained from the input audio data comprises decomposing the input audio data to obtain at least a second decomposed track which represent at least one, but not all, of the musical timbres of the piece of music, and analyzing audio data obtained from the second decomposed track.

26. Method of claim 4 or claim 17, and optionally at least one other claim of claims 1 to 25, wherein the step of obtaining output audio data further comprises generating audio data based on the musical feature, and mixing the generated audio data with audio data obtained from the input audio data.

27. Method of claim 26, wherein the musical feature relates to a tempo or a musical meter of the piece of music, wherein the generated audio data includes a periodic musical pattern, in particular a drums pattern, generated such as to have a tempo or a musical meter synchronized to the tempo or musical meter retrieved from the piece of music.

28. Method of at least one of the preceding claims, wherein the input audio data are first input audio data representing a first piece of music, wherein the method further comprises a step of providing second input audio data representing a second piece of music different from the first piece of music, and wherein the step of obtaining the output audio data comprises simultaneous processing of the first input audio data and the second input audio data.

29. Method of claim 28, wherein the step of obtaining the output audio data comprises performing a crossfade between the first piece of music and the second piece of music.

30. Method of claims 15 and 28, and optionally at least one of the preceding claims,
wherein the step of obtaining the output audio data comprises replacing at least one of the decomposed tracks obtained from decomposing the first input audio data with an audio track obtained from the second input audio data, and recombining said audio track obtained from the second input audio data with at least one of the other decomposed tracks obtained from decomposing the first input audio data.

31. Music playback system comprising
an energy input device configured to receive an energy value related to a user or an object,
an audio input device providing input audio data representing a piece of music,
a music processing device configured to obtain output audio data based on the input audio data,
an audio output device configured to output music based on the output audio data,
wherein the music processing device includes an audio effect unit for applying at least one audio effect to audio data obtained from the input audio data, and wherein the audio effect unit is adapted to be controlled by the energy value received through the energy input device.

32. Music playback system of claim 31, wherein the audio effect unit is configured to apply at least one audio filter.

33. Music playback system of claim 31 or claim 32, wherein the music processing device includes a music information retrieval unit, which is adapted to retrieve at least one musical feature of the piece of music, and wherein the audio effect unit is configured to control the audio effect based on information received from the music information retrieval unit.

34. Music playback system of claim 33, wherein the effect unit is configured to apply a periodic audio effect formed by periodically repeating an audio effect or periodically changing an effect parameter of an audio effect, wherein a timing of the periodic audio effect is based on a tempo and/or a musical meter of the piece of music retrieved as a musical feature of the piece of music by the music information retrieval unit.

35. Music playback system comprising
a energy input device configured to receive an energy value related to a user or an object,
an audio input device, providing input audio data representing a piece of music containing a mixture of different musical timbres,
a decomposition unit for decomposing the input audio data to obtain at least a first decomposed track which represents at least one, but not all, of the musical timbres, and
an audio output device configured to output music based on the first decomposed track and the energy value received through the energy input device.

36. Music playback system of claim 35, further comprising an audio effect unit for applying at least one audio effect to audio data obtained from the input audio data, and wherein the audio effect unit is adapted to be controlled by the energy value received through the energy input device and wherein the audio effect is preferably applied to the first decomposed track.

37. Music playback system of claim 35 or claim 36, wherein the music processing device includes a music information retrieval unit, which is adapted to retrieve at least one musical feature of the piece of music.

38. Music playback system of at least one of claims 35 to 37,
wherein the decomposition unit is configured to obtain a set of different decomposed tracks representing different musical timbres of the piece of music,
wherein the system further comprises a recombination unit configured to recombine at least two of the decomposed tracks to obtain a recombined track,
wherein a selection of decomposed tracks for recombination depends on the energy value and/or the musical feature, and
wherein the audio output device is configured to output music based on the recombined track.

39. Music playback system of claim 33 or claim 37, and optionally at least one other claim of claims 31 to 38, wherein the music information retrieval unit comprises a decomposition unit configured to decompose the input audio data to obtain at least a second decomposed track which represent at least one, but not all, of the musical timbres of the piece of music, and an analyzing unit configured to analyze audio data obtained from the second decomposed track in order to retrieve the musical feature.

40. Music playback system of claim 33 or claim 37, and optionally at least one other claim of claims 31 to 39, further comprising an audio generator configured to generate audio data based on the musical feature retrieved by the music information retrieval unit, and a mixing unit for mixing the audio data generated by the audio generator with audio data obtained from the input audio data.

41. Music playback system comprising
a motion input device configured to receive a motion value related to a motion of the user or an object,
an audio playback device configured to playback audio data representing a piece of music,
wherein the audio playback device includes a playback control unit configured to control playback of the audio data based on the motion value received by the motion input device,
wherein the playback control unit is configured to carry out at least one of the following control operations:
stop playback of the audio data, if the motion value indicates that a motion of the user or the object has stopped,
start playback of the audio data, if the motion value indicates that a motion of the user or the object has started,
change to playback of audio data representing a different piece of music, if the motion value indicates that a motion of the user or the object has increased from a value below a predetermined threshold value to a value above the threshold value or has decreased from a value above a predetermined threshold value to a value below the threshold value,
reverse playback direction, if the motion value indicates that a direction of the motion of the user or the object has changed.

42. Music playback system of at least one of claims 31 to 41, wherein the input audio data are first input audio data representing a first piece of music, wherein the audio input device is configured to provide second input audio data representing a second piece of music different from the first piece of music, and wherein the music processing device is configured to obtain output audio data based on parallel processing of the first input audio data and the second input audio data.

43. Music playback system of at least one of claims 31 to 42, wherein the energy input device comprises at least one of
a motion sensor adapted to detect motion of the user or the object
a vital parameter sensor adapted to detect at least one vital parameter of the user,
a brain-computer interface (BCI) measuring the electrical activity of the brain of the user.

44. Music playback system of at least one of claims 31 to 43, which is implemented by a mobile device or a wearable, preferably a smartphone, running a software application, said mobile device comprising user input means and audio output means for outputting audio signals to a user via headphones or speakers.

45. Music playback system according to at least one of the claims 31 to 43, configured to carry out a method according to at least one of the claims 1 to 30.

46. Method or system according to at least one of the preceding claims, wherein the input audio data are mixed audio files, in particular stereo audio files.

47. Method or system according to at least one of the preceding claims, wherein the input audio data are obtained via streaming from a remote server, in particular through the Internet.

48. Method or system according to at least one of the preceding claims, wherein the energy value is derived from detecting an activity of the user, including at least one of running, walking, workout, moving, and dancing.
